(19) United States
(12) Patent Application Publication
(10) Pub. No.: US 2016/0274213 A1
(43) Pub. Date: Sep. 22, 2016

(54) Matching System and Matching Method

(71) Applicant: Cheng-Long Fu, New Taipei City (TW)

(72) Inventor: Cheng-Long Fu, New Taipei City (TW)

(21) Appl. No.: 14/873,212

(22) Filed: Oct. 2, 2015

(30) Foreign Application Priority Data
Mar. 20, 2015 (TW) 104109053

(51) Int. Cl. G01S 5/02

(52) U.S. Cl. CPC G01S 5/0252; G01S 5/0289

(57) ABSTRACT

A matching system includes at least one object matching apparatus and a search matching apparatus. Each object matching apparatus includes first antennas for emitting at least one radio frequency signal. The search matching apparatus includes a distance determination module having second antennas for receiving the radio frequency signal, and calculating a relative distance information and a relative direction information corresponding to each object matching apparatus according to a signal strength value of the radio frequency signal; a direction determination module for calculating an absolute direction information of the search matching apparatus corresponding to the earth coordinate system; and a calculating module for receiving the relative distance information, the relative direction information and the absolute direction information on the earth coordinate system to calculate an relative position corresponding to each object matching apparatus.

### BACKGROUND OF THE INVENTION

1. Field of the Invention

The present disclosure relates to a matching system and a matching method, and more particularly, to a matching system and a matching method which can utilize antennas, an acceleration sensor and a compass to estimate the relative distance and the relative direction.

2. Description of the Prior Art

More portable electronic devices are available in the current market with a variety of functions. For example, the smart phone can be operated to communicate with others and to serve the Internet, and the smart bracelet can be utilized to record body/health indexes of a wearer for monitoring his/her health conditions while the wearer is practicing exercises or has his/her regular life.

However, people pay more attentions on the functions and operations of the portable electronic devices in the current market, but pay fewer attentions on the studies or researches of interactive operations for any two portable electronic devices. Furthermore, these portable electronic devices are generally equipped with the Global Positioning System (GPS) to process self-positioning or location searching operations for any interesting target(s). Once the user is operating the portable electronic device within a zone with poor signal recognition, the self-positioning or location searching operations for the user having the portable electronic device or for the interesting target(s) might be not functionally processed.

Therefore, it has become an important issue to provide a matching system and a matching method to provide interactive operations between multiple portable electronic devices with precise locating operations.

### SUMMARY OF THE INVENTION

It is therefore an objective of the disclosure to provide a matching system and a matching method to provide interactive operations between multiple portable electronic devices with precise locating operations.

An embodiment of the disclosure discloses a matching system. The matching system comprises at least one object matching apparatus, each object matching apparatus comprising a plurality of first antennas for emitting at least one radio frequency signal; and a search matching apparatus, comprising a distance determination module, comprising a plurality of second antennas for receiving the radio frequency signal emitted by each object matching apparatus, and calculating a relative distance information and a relative direction information corresponding to each object matching apparatus according to a signal strength value of the radio frequency signal; a direction determination module, comprising an acceleration sensor and a compass, for calculating an absolute direction information of the search matching apparatus corresponding to an earth coordinate system; and a calculating module, coupled to the distance determination module and the direction determination module, for receiving the relative distance information, the relative direction information and the absolute direction information on the earth coordinate system to calculate an relative position corresponding to each object matching apparatus; wherein each first antenna or each second antenna is a directional antenna or an omnidirectional antenna.

An embodiment of the disclosure also discloses a matching method for a matching system. The matching system comprises at least one object matching apparatus and a search matching apparatus. The matching method comprises utilizing a plurality of first antennas of each object matching apparatus for emitting at least one radio frequency signal; utilizing a plurality of second antennas of the search matching apparatus for receiving the radio frequency signal emitted by each object matching apparatus, to obtain a signal strength value of the radio frequency signal, so as to generate a relative distance information and a relative direction information corresponding to each object matching apparatus; utilizing an acceleration sensor and a compass for calculating an absolute direction information of the search matching apparatus corresponding to an earth coordinate system; and calculating an relative position corresponding to each object matching apparatus according to the relative distance information, the relative direction information and the absolute direction information on the earth coordinate system; wherein each first antenna or each second antenna is a directional antenna or an omnidirectional antenna.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a matching system according to an embodiment of the invention.

FIG. 2 illustrates a schematic diagram of a distance determination module according to an embodiment of the invention.

FIG. 3 illustrates a schematic diagram of an initiation rule of the plurality of antennas according to an embodiment of the invention.

FIG. 4 illustrates a schematic diagram of a relative direction determination via the antenna operation ranges of the antennas according to an embodiment of the invention.

FIG. 5 illustrates a schematic diagram of an absolute direction determination of the acceleration sensor of the direction determination module according to an embodiment of the invention.

FIG. 6 illustrates a schematic diagram of an output information according to an embodiment of the invention.

FIG. 7 illustrates a flow chart of a matching process according to an embodiment of the invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in sub-module. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

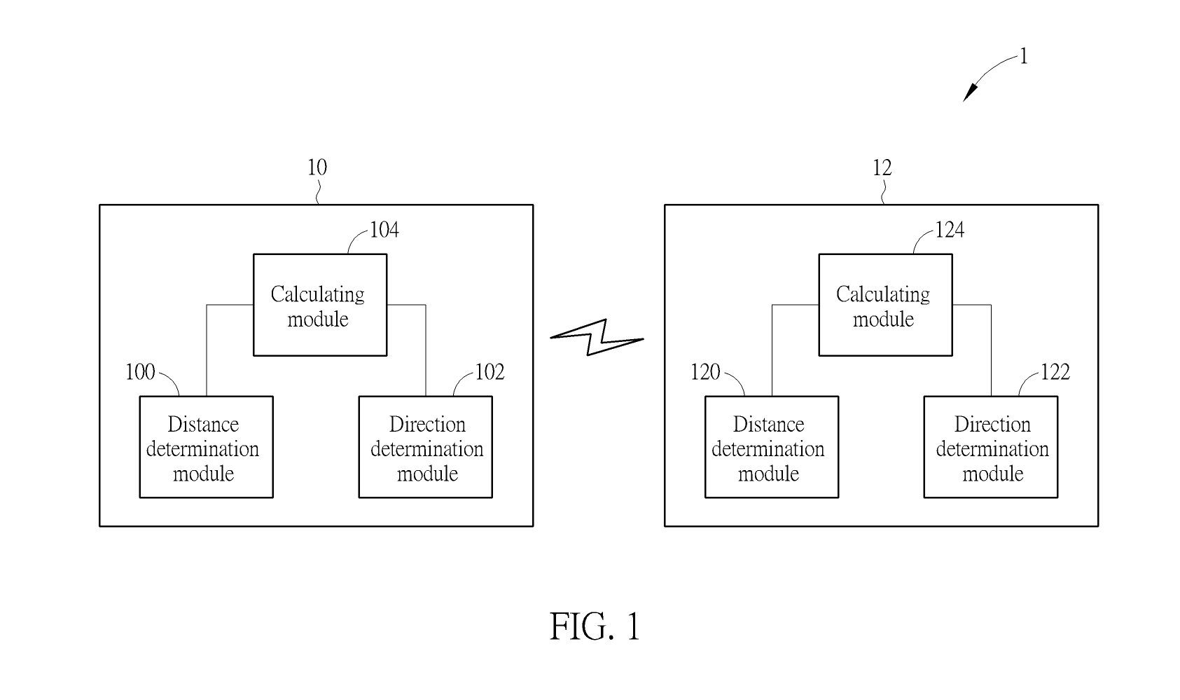

Please refer to FIG. 1, which illustrates a schematic diagram of a matching system 1 according to an embodiment of the invention. As shown in FIG. 1, the matching system 1 of the embodiment comprises at least one object matching apparatus 10 and a search matching apparatus 12, and the object matching apparatus 10 is neighboring to the search matching apparatus 12. In the embodiment, the object matching apparatus 10 comprises a distance determination module 100, a direction determination module 102 and a calculating module 104, and the search matching apparatus 12 also comprises a distance determination module 120, a direction determination module 122 and a calculating module 124. Both the distance determination module 100 and the distance determination module 120 comprise a plurality of antennas, and each antenna may be a directional antenna or an omnidirectional antenna. Both the direction determination module 102 and the direction determination module 122 comprise one acceleration sensor and one compass. The calculating module 104 is electrically connected to the distance determination module 100 and the direction determination module 102, and the calculating module 124 is electrically connected to the distance determination module 120 and the direction determination module 122. Preferably, the calculating module 104 or the calculating module 124 may comprise a central processor and a storage device. The central processor may be a processing unit or a graphic processing unit, or may be a processing module which integrates multiple processing units and multiple graphic processing units, such that the calculating module 104 or the calculating module 124 is operated to process related calculation operations and controlling functions for the object matching apparatus 10 and the search matching apparatus 12. The storage device may be, but not limited to, read-only memory (ROM), random-access memory (RAM), flash, floppy disk, hardware disk, compact disc, USB flash drive, tape, database accessed via the Internet, or other types of storage medium known to those skilled in the art, to store a program code, such that the central processor can process the program code to operate a matching method for the object matching apparatus 10 and the search matching apparatus 12.

In short, the object matching apparatus 10 and the search matching apparatus 12 can utilize radio frequency signals transmitted between both apparatuses, such that the search matching apparatus 12 can obtain a relative position of the object marching apparatus 10. Besides, the search matching apparatus 12 can process a self-locating operation to determine/detect an absolute direction of the search matching apparatus 12 corresponding to an earth coordinate system, so as to finish a positioning operation between the object matching apparatus 10 and the search matching apparatus 12 and to simultaneously process a matching operation thereof.

In the embodiment, the object matching apparatus 10 and the search matching apparatus 12 may be carried by different users, such that the search matching apparatus 12 is operated to search its neighboring for finding any object matching apparatus(s) 10. Hereinafter, the different terms for the object matching apparatus 10 and the search matching apparatus 12 are only demonstrated to clarify that, among the two apparatuses, which one actively initiates the search operation and which one passively responds to the search operation. In practical, the object matching apparatus 10 and the search matching apparatus 12 of the embodiment comprise the identical composition units and operations thereof. For the convenience, the apparatus which actively initiates the search operation is named as the search matching apparatus 12, and the apparatus which passively responds to the search operation is named as the object matching apparatus 10. Certainly, the object matching apparatus 10 passively responding to the search operation can initiate another search operation, and the search matching apparatus 12 actively initiating the search operation can also be searched by other search matching apparatuses, which is not limiting the scope of the invention.

In detail, the distance determination module 100 of the target matching apparatus 10 may transmit at least one radio frequency signal, to have the distance determination module 120 of the search matching module 12 receive the radio frequency signal transmitted by the target matching apparatus 10. In the meanwhile, the distance determination module 120 can refer to a signal strength value, such as the received signal strength indication (RSSI), of the radio frequency signal, to calculate a relative distance information and a relative direction information of the target matching apparatus 10, i.e. the distance determination module 120 of the search matching apparatus 12 in the embodiment can pre-store a look-up table to illustrate a relationship between the received signal strength value and the relative distance, so as to obtain the relative distance information of the search matching apparatus 12 corresponding to the target matching apparatus 10. Also the distance determination module 120 of the search matching apparatus 12 in the embodiment can process a relative direction method to illustrate a relationship between the received signal strength values from a plurality of antennas and the relative directions, so as to obtain the relative direction information of the search matching apparatus 12 corresponding to the target matching apparatus 10.

Besides, the acceleration sensor of the direction determination module 122 may detect a gravity constant value along different axis in a three dimensional space and a value change of a tilt, and the compass of the direction determination module 122 may detect a deflection corresponding to the earth coordinate system, such that the direction determination module 122 may calculate an absolute direction information of the search matching apparatus 12 corresponding to the earth coordinate system. The calculating module 124 of the search matching apparatus may receive the relative distance information, the relative direction information, and the absolute direction information on the earth coordinate system, to calculate a relative position of the search matching apparatus 12 corresponding to the target matching apparatus 10, i.e. the calculating module 124 can determine the distance and the direction of the other target matching apparatuses) corresponding to the search matching apparatus 12, so as to precisely locate the position and direction between the target matching apparatus 10 and the search matching apparatus 12, such that the user of the search matching apparatus 12 can be informed that whether one target matching apparatus 10 neighbors the search matching apparatus 12 and whether an interactive operation corresponding to the matching operation should be correspondingly performed for the target matching apparatus 10 and the search matching apparatus 12. More detailed operations are presented in the following paragraphs.

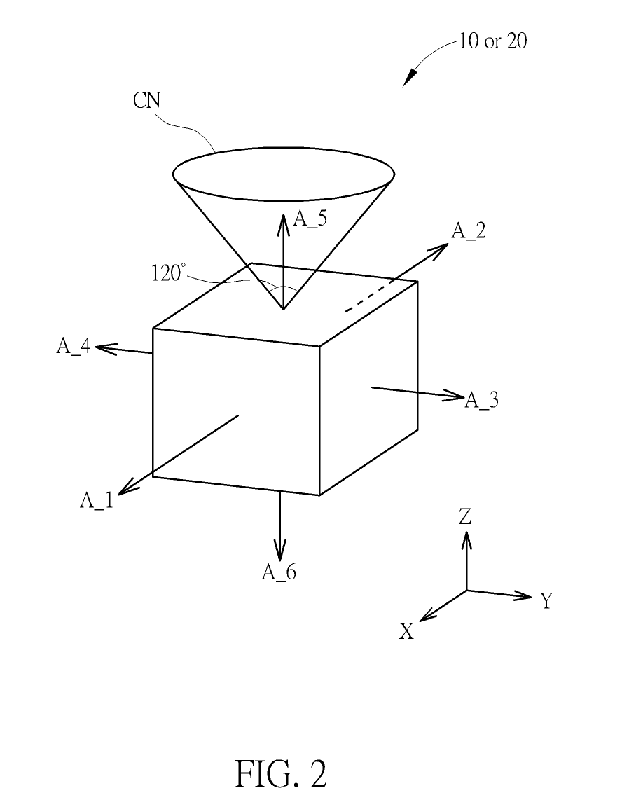

Please refer to FIG. 2, which illustrates a schematic diagram of a distance determination module 100 (or a distance determination module 120) according to an embodiment of the invention. As shown in FIG. 2, the distance determination module 100 (or the distance determination module 120) of the embodiment is structurally formed as a cube and comprises six antennas A_1-A_6, i.e. emitting directions or reception directions of the antennas A_1-A_6 are perpendicular to six planes of the cube, respectively, to correspondingly receive or emit the radio frequency signals. In the embodiment, all the antennas A_1-A_6 are omnidirectional antennas, but are not limiting the scope of the invention. Accordingly, the emitting/reception directions of the antennas A_1-A_6 in the search matching apparatus 12 or the target matching apparatus 10 are disposed to point along the +X axis, the −X axis, the +Y axis, the −Y axis, the +Z axis and the −Z axis (i.e. the six absolute directions in the three dimensional space), and any two of the absolute directions are perpendicular to each other to represent the X axis, the Y axis and the Z axis of the three dimensional space, such that the radio frequency signals can be mapped onto the three axes of the three dimensional space. Certainly, any two antennas can be adaptively designed to be disposed along any two directions, which are not perpendicular to each other, according to the realization of the distance determination modules 100 and 120, which is also within the scope of the invention. Besides, each antenna disposed along each absolute direction corresponds to an antenna operation range, such as the antenna A_5 disposed along the +Z axis corresponds to an antenna operation range CN with 120 degrees, such that the radio frequency signal(s) within the 120 degrees of the antenna operation range CN can be correspondingly received or emitted by the antenna A_5. The other antennas disposed along different axes in the three dimensional space also have the individual antenna operation ranges with 120 degrees to cover all the radio frequency signals neighboring the distance determination module 120.

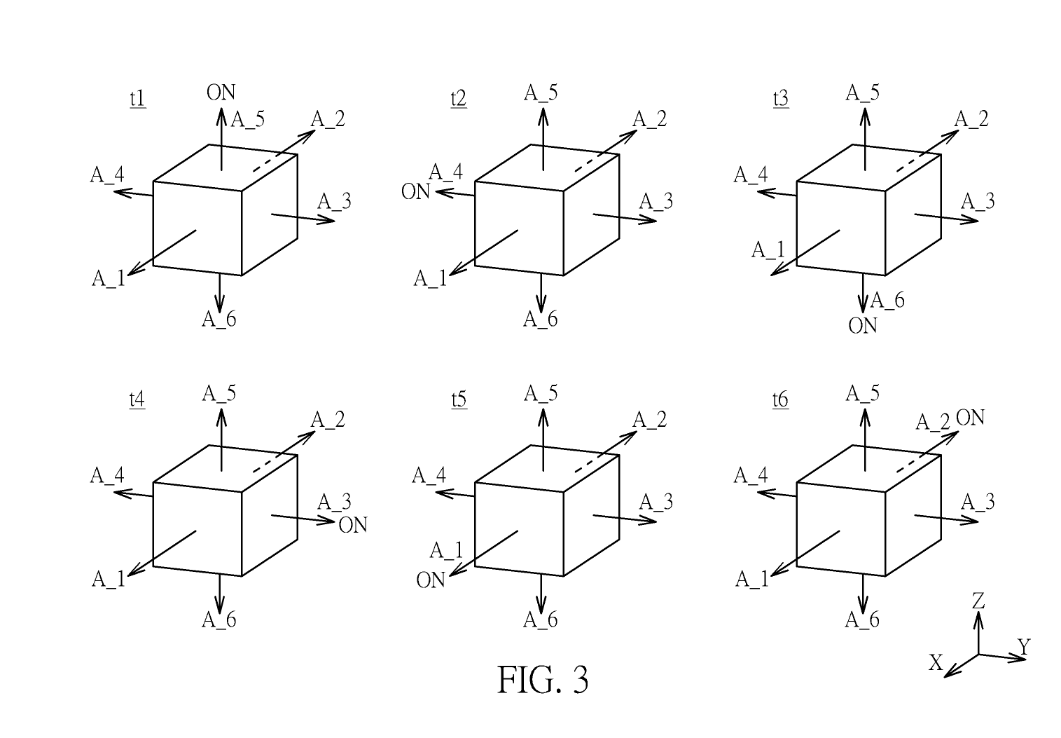

Please refer to FIG. 3, which illustrates a schematic diagram of an initiation rule of the plurality of antennas A_1-A_6 according to an embodiment of the invention. As shown in FIG. 3, the antennas A_1-A_6 disposed along different absolute directions of the embodiment may comply with the predetermined initiation rule, to be sequentially initiated for emitting or receiving the radio frequency signals. For example, in a first operational period t1, the antenna A_5 disposed along the +Z axis can be correspondingly initiated to emit or receive the radio frequency signals; in a second operational period t2 after the first operational period t1, the antenna A_4 disposed along the −Y axis can be correspondingly initiated to emit or receive the radio frequency signals; in a third operational period t3 after the second operational period t2, the antenna A_6 disposed along the −Z axis can be correspondingly initiated to emit or receive the radio frequency signals; in a fourth operational period t4 after the third operational period t3, the antenna A_3 disposed along the +Y axis can be correspondingly initiated to emit or receive the radio frequency signals; in a fifth operational period t5 after the fourth operational period t4, the antenna A_1 disposed along the +X axis can be correspondingly initiated to emit or receive the radio frequency signals; in a sixth operational period t6 after the fifth operational period t5, the antenna A_2 disposed along the −X axis can be correspondingly initiated to emit or receive the radio frequency signals. In other words, the mentioned initiation rule of the embodiment is initially applied to the antennas disposed along the YZ plane to be counterclockwise initiated, and then is applied to the antennas along the +X axis and the −X axis, so as to finish the initiation operation of the antennas A_1-A_6. Accordingly, the completed initiation operation of the six antennas A_1-A_6 may correspond to one cycle operation of the antennas A_1-A_6, i.e. the antennas A_1-A_6 in each cycle operation can be sequentially initiated to emit or receive the radio frequency signals. In other embodiments, those skilled in the art can also adaptively modify or adjust the initiation rule for the antennas A_1-A_6 according to different requirements or environmental restrictions, which is not limiting the scope of the invention.

Moreover, in one embodiment, a reception operation period of one antenna receiving the radio frequency signal is an emitting operation period of one antenna emitting the radio frequency signal multiplied by a fixed number. In other words, if the reception operation period of the antenna is RT and the emitting operation period of the antenna is TT, the reception operation period RT can be the emitting operation period of the antenna TT multiplied by a fixed number K, i.e. RT=TTxK. For example, the embodiment of the invention can predetermine that the reception operation period RT is sixth times the duration of the transmission operation TT, i.e. the period for receiving the radio frequency signals of each antenna in the search matching apparatus 12 can be equivalent to the period for the six antennas in the target matching apparatus 10 emitting the radio frequency signals. Thus, the antenna disposed along each absolute direction can have enough time for receiving the at least one radio frequency signal emitted from the antennas disposed along the six absolute directions, and the search matching apparatus 12 can correspondingly record the information about which antenna emits the radio frequency signal and which antenna receives the radio frequency signal for the following operations.

Under such circumstances, the distance determination module 120 of the search matching apparatus 12 in the embodiment predetermines the initiation rule, and the antennas A_1-A_6 of the distance determination module 120 correspondingly receive the at least one radio frequency signal from the target matching apparatus 10 within the antenna operation ranges. Accordingly, the distance determination module 120 can obtain the signal strength value of the radio frequency signal, and compares the signal strength value with a pre-stored threshold value in the distance determination module 120 to generate the relative distance information and the relative direction information corresponding to the target matching apparatus(es).

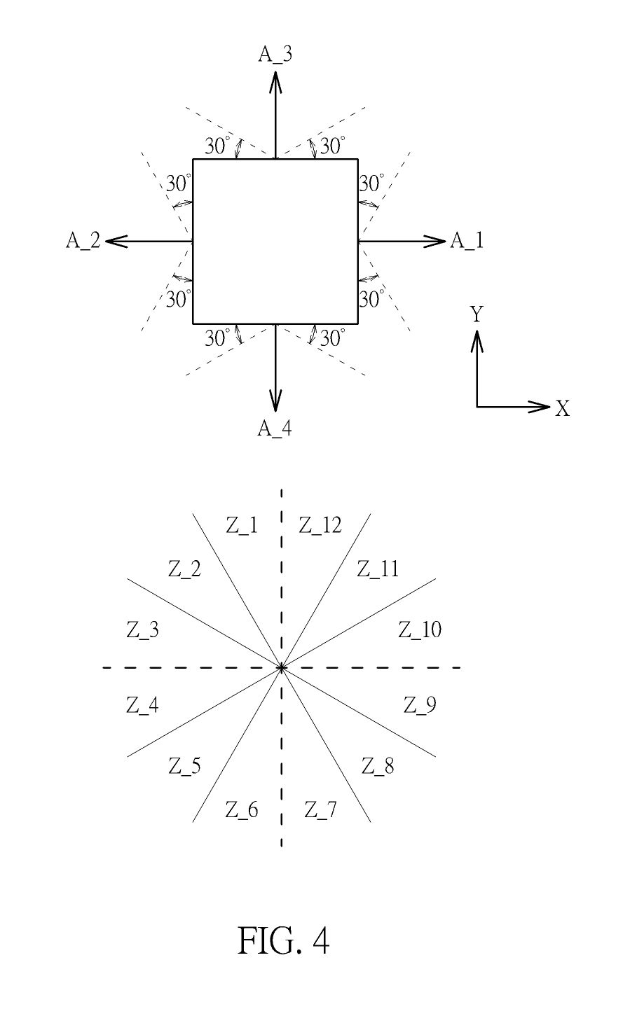

In another embodiment, the distance determination module 120 further refers to the antenna operation ranges of different antennas disposed along different absolute directions, to correspondingly determine the relative direction of the received radio frequency signal. For example, please refer to FIG. 4, which illustrates a schematic diagram of a relative direction determination via the antenna operation ranges of the antennas A_1-A_4 according to an embodiment of the invention. As shown in FIG. 4, since each one of the antennas A_1-A_4 has the antenna operation range with 120 degrees, the distance determination module 120 can adaptively divide the X-Y plane into 12 operation zones Z_1-Z_12 according to the configuration of the antennas A_1-A_4. It is assumed that the antenna A_1 receives the radio frequency signal having the signal strength value as RSSI_A1 and the antenna A_3 receives the radio frequency signal having the signal strength value as RSSI_A3. If the signal strength value RSSI_A3 subtracting from the signal strength value RSSI_A1 is larger than zero and the threshold value, the distance determination module 120 can determine that the radio frequency signal comes from the operation zone Z_10. Similarly, if the signal strength RSSI_A3 subtracting from the signal strength value RSSI_A1 is smaller than the threshold value, the distance determination module 120 can determine that the radio frequency signal comes from the operation zone Z_11. If the signal strength value RSSI_A3 subtracting from the signal strength value RSSI_A1 is smaller than zero and the threshold value, the distance determination module 120 can determine that the radio frequency signal comes from the operation zone Z_12. In that, the distance determination module 120 can corresponding obtain the relative direction information of the received radio frequency signal.

Under such circumstances, the distance determination module 120 of the embodiment can refer to the look-up table recording the signal strength values to obtain the relative distance information and the relative direction information of the target matching apparatus 10, and can also refer to the differences between the threshold value and the signal strength values of the multiple antennas to correspondingly obtain the relative direction information of the target matching apparatus 10, such that a direction and an estimated distance of the relative position between the target matching apparatus 10 and the search matching apparatus 12 can be determined. Further, since the embodiment of the invention presents the calculation of the relative position on the XY plane between the target matching apparatus 10 and the search matching apparatus 12, related calculations of the relative position on the XZ plane or on the YZ plane can refer to the calculation of the relative position on the XY plane, such that the search matching apparatus 12 in the three dimensional space can precisely determine whether there is any target matching apparatus 10 neighboring the search matching apparatus 12, and can simultaneously determine where does the radio frequency signal come from for correspondingly obtaining the relative distance information and the relative direction information between the target matching apparatus 10 and the search matching apparatus 12.

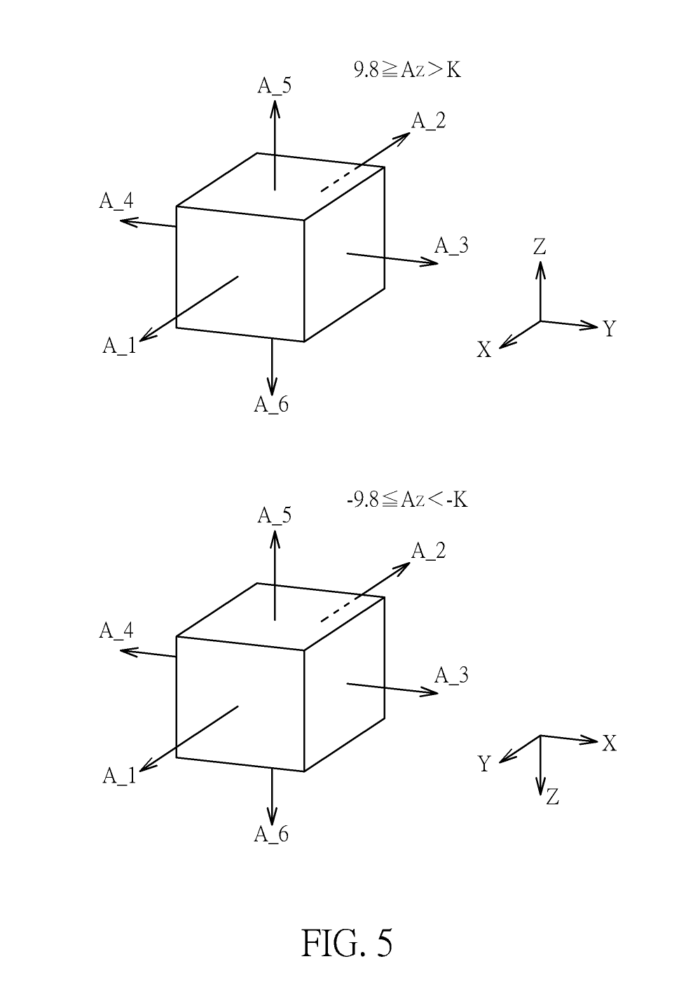

Additionally, the acceleration sensor of the direction determination module 122 in the embodiment can sense/detect a rotating condition of the search matching apparatus 12 operated by the user, to sense the change of the gravity constant value at different axes in the three dimensional space, so as to compare the change of the gravity constant value and a threshold value for calculating the absolute direction information of the search matching apparatus 12 corresponding to the earth coordinate system. For example, please refer to FIG. 5, which illustrates a schematic diagram of an absolute direction determination of the acceleration sensor of the direction determination module 122 according to an embodiment of the invention. As shown in FIG. 5, when the acceleration sensor senses an acceleration Az along the Z axis being smaller than the gravity acceleration (i.e. g=9.8 m/s²) of the earth coordinate system and larger than a threshold value K, it is determined that the antenna A_1 is disposed along the +X axis, the antenna A_2 is disposed along the −X axis, the antenna A_3 is disposed along the +Y axis, the antenna A_4 is disposed along the −Y axis, the antenna A_5 is disposed along the +Z axis and the antenna A_6 is disposed along the −Z axis. When the acceleration sensor senses the acceleration Az along the Z axis being larger than a negative value of the gravity acceleration (i.e. g=9.8 m/s²) of the earth coordinate system and smaller than a threshold value −K, it is determined that the antenna A_3 is disposed along the +X axis, the antenna A_4 is disposed along the −X axis, the antenna A_1 is disposed along the +Y axis, the antenna A_2 is disposed along the −Y axis, the antenna A_6 is disposed along the +Z axis and the antenna A_5 is disposed along the −Z axis. Similarly, in other embodiments, the direction determination module 122 can utilize the acceleration sensor to detect/sense value changes of the accelerations Ax and Ay being along the X axis and the Y axis, respectively, so as to obtain the disposition of different antennas and the search matching apparatus 12 in the three dimensional space for obtain a pointing direction or a disposition direction of each antenna in the search matching apparatus 12.

Further, the acceleration sensor in the embodiment can adaptively refer to the value change of the acceleration along the X axis, the Y axis or the Z axis, to obtain a tilt information of the search matching apparatus 12 corresponding to a horizontal plane (such as the XY plane), i.e. the acceleration sensor can correspondingly obtain the tilt of the search matching apparatus 12 associated with any reference plane for the following operations.

Moreover, the compass of the direction determination module 122 in the embodiment can detect/sense the deflection corresponding to the earth coordinate system, i.e. the compass of the embodiment can detect the deflection derived from a pointing direction of the search matching apparatus 12 corresponding to the magnetic north pole of the earth coordinate system. Accordingly, the calculating module 124 of the embodiment can utilize a disposition direction in the three dimensional space generated by the acceleration sensor and the tilt corresponding to one horizontal plane, to cooperate with the compass generating the deflection corresponding to the magnetic north pole, so as to locate the search matching apparatus 12 corresponding to the earth coordinate system and to generate the absolute direction information, such that the absolute direction information of the search matching apparatus 12 corresponding to the earth coordinate system can be calculated, and the search matching apparatus 12 can also precisely process the positioning operation without the assistance of the GPS.

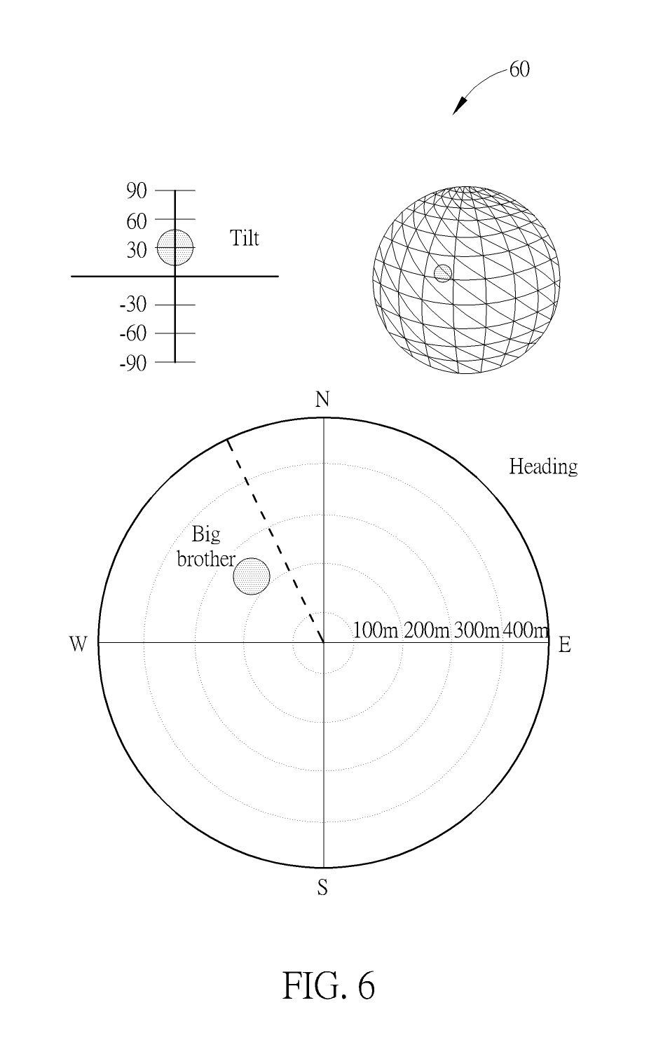

In other words, while the search matching apparatus 12 searches its neighboring space to determine whether any target matching apparatus 10 exists, the search matching apparatus 12 can also process the positioning operation thereof, such that the search matching apparatus 12 can determine the relative distance information and the relative direction information of the search matching apparatus 12 corresponding to the target matching apparatus 10, and can simultaneously determine the absolute direction information on the earth coordinate system of the search matching apparatus 12. Accordingly, the relative distance information, the relative direction information and the absolute direction information on the earth coordinate system may be correspondingly outputted as an output information 60, as shown in FIG. 6. The output information 60 comprises the tilt information of the search matching apparatus 12, the pointing information Heading and the position information corresponding to the target matching apparatus 10. For example, a radar diagram is depicted in FIG. 6, where the center point of the radar diagram is the position of the searching matching apparatus 12 and the circle marked on the radar diagram is the target matching apparatus 10. Also, the direction information and the distance information of the target matching apparatus 10 and the search matching apparatus 12 may be shown on the radar diagram. For those skilled in the art, the direction information and the distance information shown in FIG. 6 can also be depicted/illustrated onto different coordinate positioning diagram, which is not limiting the scope of the invention.

Preferably, the radio frequency signal transmitted between the search matching apparatus 12 and the target matching apparatus 10 can comprise the signal strength value, and, in another embodiment, can further comprise an antenna information and the absolute direction information of the search matching apparatus 12 (or the target matching apparatus 10). In other words, in order to clearly showing the source/origin of the radio frequency signal for improving the signal recognition between the multiple target matching apparatuses 10 and the search matching apparatuses 12, the radio frequency signal can further carry the source/origin information representing which antenna disposed at one absolute direction generates the radio frequency signal, i.e. the antenna information is utilized to represent the source antenna of the radio frequency signal. In the meanwhile, the radio frequency signal can also carry the absolute direction information of the emitter (i.e. the target matching apparatus 10) corresponding to the earth coordinate system, to assist the receiver (i.e. the search matching apparatus 12) for directly recognizing the relative position, which is also within the scope of the invention.

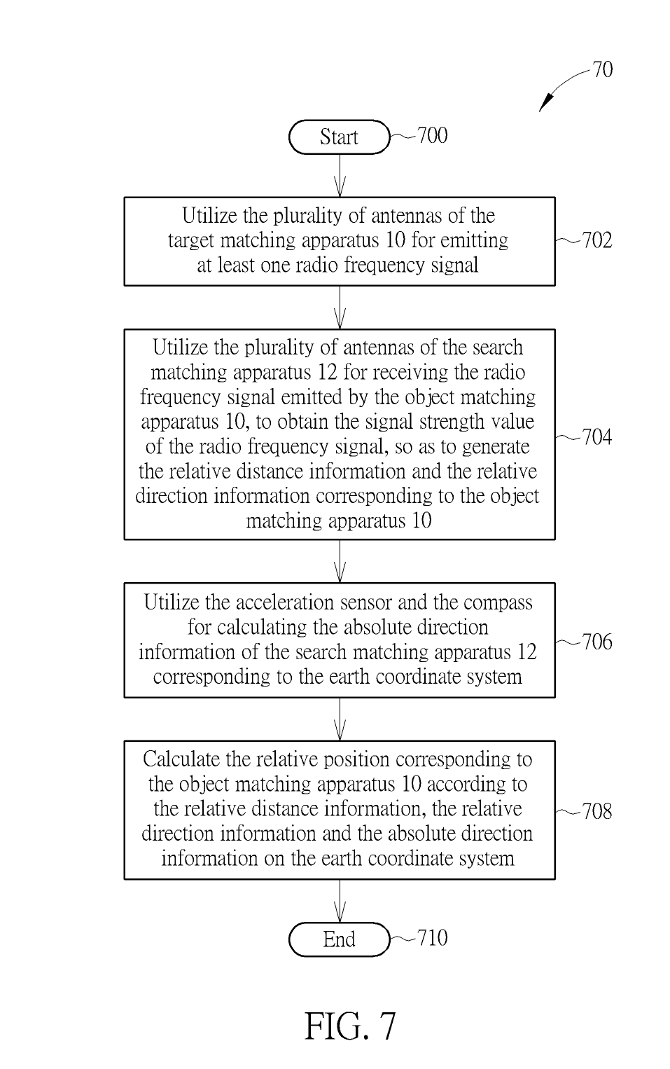

Further, the matching method for the matching system 1 of the embodiment can be summarized as a matching process 70 to be compiled as the program code stored in a storage device of the calculating module 104 or the calculating module 124, as shown in FIG. 7. The matching process includes the steps as follows.

Step 700: Start.

Step 702: Utilize the plurality of antennas of the target matching apparatus 10 for emitting at least one radio frequency signal.

Step 704: Utilize the plurality of antennas of the search matching apparatus 12 for receiving the radio frequency signal emitted by the object matching apparatus 10, to obtain the signal strength value of the radio frequency signal, so as to generate the relative distance information and the relative direction information corresponding to the object matching apparatus 10.

Step 706: Utilize the acceleration sensor and the compass for calculating the absolute direction information of the search matching apparatus 12 corresponding to the earth coordinate system.

Step 708: Calculate the relative position corresponding to the object matching apparatus 10 according to the relative distance information, the relative direction information and the absolute direction information on the earth coordinate system.

Step 710: End.

Preferably, the detailed operations of the matching process 70 can be understood via FIG. 1 to FIG. 6 and related paragraphs thereof, which is not described hereinafter for brevity. In the embodiment, for conveniently managing more than one users operating the target matching apparatus 10 and the search matching apparatus 12 in the matching system 1, the program code of the matching process 70 can also be stored in the storage device of the target matching apparatus 10 and the search matching apparatus 12, to independently operate the target matching apparatus 10 and the search matching apparatus 12 for processing the search operation and the matching operation, so as to improve the processing efficiency of the target matching apparatus 10 and the search matching apparatus 12, which is also within the scope of the invention.

In short, the search matching apparatus 12 of the embodiment can utilize the plurality of antennas to search the at least one neighboring target matching apparatus 10, so as to detect/sense the relative distance information and the relative direction information thereof. Also, the target matching apparatus 10 can utilize the acceleration sensor and the compass to locate/position its position for obtaining the tilt information and the deflection information corresponding to the earth coordinate system, so as to obtain the absolute direction information corresponding to the earth coordinate system. Accordingly, the target matching apparatus 10 and the search matching apparatus 12 can be precisely located in the earth coordinate system according to the relative distance information, the relative direction information and the absolute direction information on the earth coordinate system, so as to process the matching operation between the target matching apparatus 10 and the search matching apparatus 12. In the meanwhile, the target matching apparatus 10 and the search matching apparatus 12 can also be adaptively designed to be conveniently carried by the user(s), such as hanging the target/search matching apparatus on the neck or wearing the target/search matching apparatus on the wrist. Besides, the target matching apparatus 10 and the search matching apparatus 12 can also be designed as an independent electronic module to be integrated inside one portable electronic device, e.g. smart phone, smart bracelet, watch or beacon, etc., which is also within the scope of the invention.

Furthermore, while the target matching apparatus 10 and the search matching apparatus 12 have completed the matching operation thereof, those skilled in the art can also adaptively modify or design the interactive operations for the target matching apparatus 10 and the search matching apparatus 12. For example, a hint through voices, audios, lights or wording messages can be utilized to show that the target matching apparatus 10 and the search matching apparatus 12 have been electronically connected and matched. In the meanwhile, applications, basic contact information or hobbits can also be share between the users of the target matching apparatus 10 and the search matching apparatus 12 via a demonstration of a user interface if the users of the target matching apparatus 10 and the search matching apparatus 12 give their permission of the sharing, and accordingly, more detailed information associated with the personal information or to be utilized in some social websites or forums can also be shared/interchanged, or some instant messages or media entertainment related to one specific application can also be processed together by the users of the target matching apparatus 10 and the search matching apparatus 12, which is also within the scope of the invention.

In summary, the embodiment of the invention provides a matching system and a matching method thereof. Through operations of the plurality of antennas, the acceleration sensor and the compass, the user carrying one matching apparatus can precisely detect/sense a relative position of the other user carrying another matching apparatus, to process the matching operation of the two matching apparatuses, so as to improve the application range of the smart portable electronic devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A matching system, comprising:
at least one object matching apparatus, each object matching apparatus comprising a plurality of first antennas for emitting at least one radio frequency signal; and
a search matching apparatus, comprising:
a distance determination module, comprising a plurality of second antennas for receiving the radio frequency signal emitted by each object matching apparatus, and calculating a relative distance information and a relative direction information corresponding to each object matching apparatus according to a signal strength value of the radio frequency signal;
a direction determination module, comprising an acceleration sensor and a compass, for calculating an absolute direction information of the search matching apparatus corresponding to an earth coordinate system; and
a calculating module, coupled to the distance determination module and the direction determination module, for receiving the relative distance information, the relative direction information and the absolute direction information on the earth coordinate system to calculate an relative position corresponding to each object matching apparatus;
wherein each first antenna or each second antenna is a directional antenna or an omnidirectional antenna.

2. The matching system of claim 1, wherein emitting directions or reception directions of the plurality of first antennas and the plurality of second antennas are disposed along six absolute directions.

3. The matching system of claim 2, wherein the plurality of first antennas and the plurality of second antennas disposed at different absolute directions are sequentially initiated to emit or receive the radio frequency signal according to an initiation rule.

4. The matching system of claim 2, wherein each second antenna corresponds to an antenna operation range along each absolute direction, and the distance determination module of the search matching apparatus generates the relative distance information and the relative direction information according to a threshold value and the signal strength value within a plurality of antenna operation ranges.

5. The matching system of claim 1, wherein a reception operation period of each second antenna receiving the radio frequency signal is an emitting operation period of each first antenna emitting the radio frequency signal multiplied by a fixed number.

6. The matching system of claim 1, wherein the absolute direction information comprises a deflection information corresponding to a magnetic north pole and a tilt information corresponding to a horizontal plane, and the acceleration sensor is utilized to generate the tilt information and the compass is utilized to generate the deflection information.

7. The matching system of claim 1, wherein the radio frequency signal further comprises a second antenna information or the absolute direction information of the search matching apparatus, and the second antenna information is utilized to represent a source antenna of the radio frequency signal.

8. A matching method for a matching system, which comprises at least one object matching apparatus and a search matching apparatus, the matching method comprising:
utilizing a plurality of first antennas of each object matching apparatus for emitting at least one radio frequency signal;
utilizing a plurality of second antennas of the search matching apparatus for receiving the radio frequency signal emitted by each object matching apparatus, to obtain a signal strength value of the radio frequency signal, so as to generate a relative distance information and a relative direction information corresponding to each object matching apparatus;
utilizing an acceleration sensor and a compass for calculating an absolute direction information of the search matching apparatus corresponding to an earth coordinate system; and
calculating an relative position corresponding to each object matching apparatus according to the relative distance information, the relative direction information and the absolute direction information on the earth coordinate system;
wherein each first antenna or each second antenna is a directional antenna or an omnidirectional antenna.

9. The matching method of claim 8, wherein emitting directions or reception directions of the plurality of first antennas and the plurality of second antennas are disposed along six absolute directions.

10. The matching method of claim 9, further comprising utilizing an initiation rule to have the plurality of first antennas and the plurality of second antennas disposed at different absolute directions be sequentially initiated to emit or receive the radio frequency signal.

11. The matching method of claim 9, wherein each second antenna corresponds to an antenna operation range along each absolute direction, and the matching method further comprises generating the relative distance information and the relative direction information according to a threshold value and the signal strength value within a plurality of antenna operation ranges.

12. The matching method of claim 8, wherein a reception operation period of each second antenna receiving the radio frequency signal is an emitting operation period of each first antenna emitting the radio frequency signal multiplied by a fixed number.

13. The matching method of claim 8, wherein the absolute direction information comprises a deflection information corresponding to a magnetic north pole and a tilt information corresponding to a horizontal plane, and the matching method further comprises utilizing the acceleration sensor to generate the tilt information and utilizing the compass to generate the deflection information.

14. The matching method of claim 8, wherein the radio frequency signal further comprises a second antenna information or the absolute direction information of the search matching apparatus, and the second antenna information is utilized to represent a source antenna of the radio frequency signal.
